(19) United States
(12) Patent Application Publication
(10) Pub. No.: US 2004/0038094 A1
(43) Pub. Date: Feb. 26, 2004

(54) Fuel cell system

(76) Inventors: Martin Klenk, Backnang (DE); Thorsten Allgeier, Heilbronn (DE); Ian Faye, Stuttgart (DE); Tilo Landenfeld, Vaihingen/Enz (DE); Rainer Saliger, Freiberg (DE)

Correspondence Address: KENYON & KENYON, ONE BROADWAY, NEW YORK, NY, 10004, US

(21) Appl. No.: 10/436,721

(22) Filed: May 12, 2003

(30) Foreign Application Priority Data
May 10, 2002 (DE) 102 20 776.3

(51) Int. Cl. H01M 8/06; B60L 11/18

(52) U.S. Cl. 429/20; 180/65.3

(57) ABSTRACT

A fuel cell system has a combustion device, a fuel cell unit and a reformer for transforming fuel into a reformed gas, the combustion device having at least one exhaust pipe as an outlet for exhaust gas, the use of such a fuel cell system resulting in a marked reduction in the additional energy that may be required for heating the transforming unit. This is achieved by positioning at least one heat exchanger unit at the exhaust pipe for heating a heating fluid and/or a fuel of the reformer, using the heat from the exhaust gas stream.

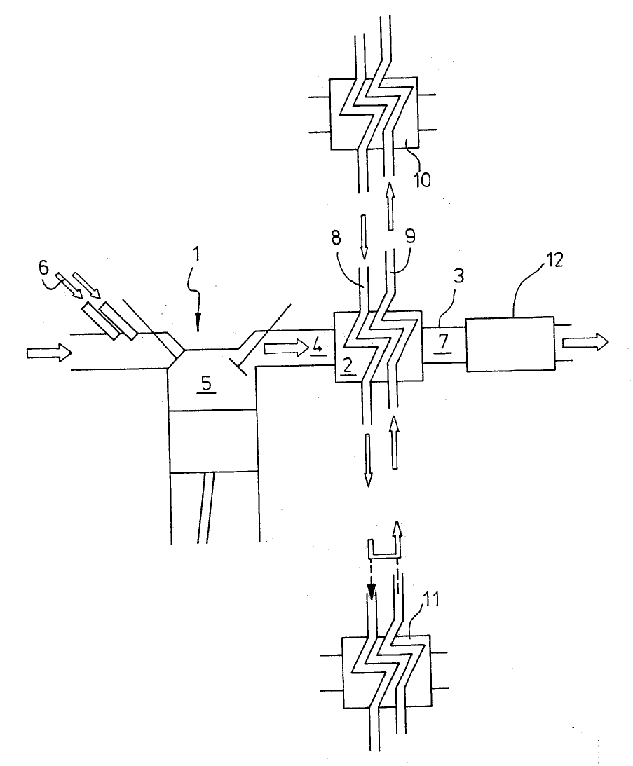

### FIELD OF THE INVENTION

The present invention relates to a fuel cell system having a combustion device, a fuel cell unit and a transforming unit, hereinafter referred to as a “reformer,” for transforming hydrocarbon-containing mixtures of substances, hereinafter referred to as “fuel,” into a hydrogen-containing fluid, hereinafter referred to as “reformed gas”.

### BACKGROUND INFORMATION

In vehicles, for example, the practice has been for some time to provide, in addition to the internal combustion engine, a fuel cell, or a fuel cell stack, either of which is powered by a hydrogen-containing fluid produced “on board”. In hybrid vehicles, the electrical power produced by the fuel cell unit is used, among other things, as an additional power source via an electric motor and/or as an auxiliary power unit (APU) for supplying the electrical sub-units of the vehicle.

Frequently, the hydrogen required by the fuel cell unit is produced “on board” through auto-thermal and/or steam reforming of the hydrocarbon-containing fuel, e.g., gasoline, diesel or natural gas, using an appropriate reformer.

During the start-up phase, it is generally necessary to supply the reformer with heat energy, for example through an electric heater, to ensure the required operating temperature for the reaction of the fuel with atmospheric oxygen. Depending on the choice of the reforming process, water may also be required, which is often heated or vaporized for this purpose.

One disadvantage in traditional systems is the large amount of electrical power required to heat the reformer and its fuels, in particular during start-up.

### SUMMARY OF THE INVENTION

An object of the present invention is to propose, in contrast to the related art, a fuel cell system having a combustion device, a fuel cell unit and a reformer for the transformation of fuels into a reformed gas, the combustion device being equipped with at least one exhaust pipe to allow exhaust gas to escape, which will achieve a marked reduction in the additional power that may be required for heating the transforming unit.

A fuel cell system according to the present invention is therefore characterized by positioning at the exhaust pipe at least one heat exchanger unit for heating a heating fluid and/or a fuel of the transforming unit, using the residual heat from the exhaust gas stream.

The heat exchanger unit according to the present invention offers the advantage of enabling the utilization of exhaust gas energy from the combustion device that has so far not been utilized, in order to heat the reformer, or the transforming unit, particularly rapidly and in an energy-efficient manner. This may render a separate electric or similar heating unit unnecessary, either completely or at least in part.

Due to the high exhaust gas temperatures during the combustion of fuel in the combustion device, high temperatures are reached along the exhaust pipe, even in a relatively short time. Their enthalpy can be passed on through the heat exchanger according to the present invention to the operating media of the transforming unit and/or, where applicable, to a separate heating fluid in order to heat the transforming unit.

Where applicable, heat can be introduced into the transforming unit through almost continuous operation of the heat exchanger, using the exhaust gas energy from the combustion device, whereby the present invention advantageously offers the transition from auto-thermal reforming to endothermal steam reforming which has a significantly higher efficiency in terms of hydrogen generation. This reduces dramatically, or makes unnecessary, the aspiration and compression of air for the reforming process. The fuel cell system offers the advantage that it is operatable with an almost minimal loss of efficiency from the parasitic power of air compressors and such like at increased operating pressures. In addition, improved adjustability between auto-thermal reforming and steam reforming may result according to the present invention.

A special refinement of the present invention is the positioning of the heat exchanger unit in the proximity of an outflow opening in the combustion device. The heat exchanger unit is, for example, located at an exhaust elbow. The exhaust pipe is particularly hot, or heats up relatively rapidly, in the immediate area surrounding the outflow opening, with the result that the reformer or the transforming unit may also be heated rapidly and/or intensively, and that a relatively large amount of heat energy can be passed on to the transforming unit.

The transforming unit fuel that has to be heated offers the advantage that it includes, at least in part, the hydrocarbon-containing mixture of substances, air and/or water. This allows, for example, heating of the transforming unit from the inside, or directly on possibly catalytically active reaction surfaces of the transforming unit, with the result that the start-up phase, i.e., heating of the transforming unit to operating temperature, is achieved relatively rapidly and in an energy-efficient manner.

A special refinement of the present invention provides for at least one metering element to meter the fuel and/or the heating fluid. This makes possible the improved control or regulation of the heating of the transforming unit. Controlled heating of the transforming unit may be implemented through the use of throttle valves or similar means that alter the mass flow of the fuel to be heated.

As an improvement, a multiple heat exchanger may, for example, be positioned on, or flanged to, the exhaust elbow that is generally made of metal, so that in particular multiple fuels, or at least one fuel and a separate heating fluid, may flow almost simultaneously through the heat exchanger to absorb the exhaust gas energy, thereby effecting a particularly advantageous heating of the transforming unit inside and/or outside.

Preferably, at least one catalytically active exhaust-gas purification device is provided. For example, a so-called catalytic converter that is already on the market may be used to clean the exhaust gas stream. This allows the reduction of environmentally relevant exhaust emissions.

In an advantageous version of the present invention, the exhaust-gas purification device is positioned downstream from the heat exchanger unit. This measure ensures that, by giving off heat to the heat exchanger, a cooling down of the exhaust gas flowing towards the exhaust-gas purification device is achieved. Overheating of the exhaust-gas purification device is thus avoided, in particular at relatively high or maximum capacity of the combustion device. The reduction of thermal stress on the exhaust-gas purification device offers the advantage of significantly extending its life span and improving its useful life.

In addition, full-load enrichment, as currently used in particular in gasoline engines, becomes unnecessary with the consequence that the otherwise increased fuel consumption associated with it also becomes unnecessary due to the additional fuel, or mixture of substances, introduced for cooling down the exhaust gas at full load. As a result, a particularly environment-friendly operation of the combustion device and of the vehicle according to the present invention can be achieved.

The exhaust-gas purification device is advantageously positioned near the heat exchanger unit. For example, until the operating temperature of the exhaust-gas purification device is reached, i.e. until what is called light-off, an advantageous control to a large extent prevents heat being transferred via the heat exchanger unit so that, in particular where the exhaust-gas purification device is positioned relatively close to the engine, it reaches its operating temperature relatively rapidly. Catalyst light-off is hereby sped up significantly and as a result, in particular during start-up of the combustion device and of the exhaust-gas purification device, markedly less environmentally-relevant exhaust gas emissions are generated.

In an improved version of the present invention, at least one accumulator device is provided for storing the reformed gas. By using an appropriate accumulator device, hydrogen generation and hydrogen utilization may take place at different times in particular. In particular during start-up, for example, the combustion device can be operated almost exclusively using reformed gas, resulting in a particularly drastic reduction of environmentally-relevant raw exhaust gas emissions.

If necessary, the combustion device may be operated in mixed operation during start-up. This means that a mixture of reformed gas and fuel is supplied to the combustion device.

In addition, rich operation of the combustion device, i.e., using an excess of hydrogen and, if necessary, secondary air injection, may be used to achieve even faster catalyst light-off. Particularly intense and rapid heating up of the exhaust-gas purification device is achieved because during this operation hydrogen, whose exothermal transformation is achievable even at room temperature on appropriate catalytically active surfaces, is not fully transformed in the combustion device and is present in the exhaust gas so that the catalyst, or the exhaust-gas purification device, is rapidly heated up. The same may be accomplished by means of mixed rich/lean operation of the combustion device, distributed over the individual cylinders, without secondary air injection.

Through mixed operation of the combustion device, e.g., using a mixture of fuel and reformed gas, the present invention offers the additional improvement of achieving a marked increase in exhaust gas recirculation rates (EGR rates) as compared to pure fuel or gasoline operation. Such high exhaust gas recirculation rates have the effect, by dethrottling the engine or the combustion device, of achieving a marked increase in efficiency and may therefore result in a particularly low overall fuel consumption in the vehicle. Such a high exhaust gas recirculation rate may be achieved in particular because of the relatively wide ignition range of hydrogen as compared to that of gasoline.

### BRIEF DESCRIPTION OF THE DRAWING

The Figure is a diagram showing an internal combustion engine 1 having a heat exchanger 2 according to the present invention. Heat exchanger 2 is in particular flanged to exhaust pipe 3, i.e., as close as possible to an outflow opening 4 of internal combustion engine 1.

### DETAILED DESCRIPTION

In a combustion chamber 5, a fuel-air mixture is generally burned. This process creates relatively hot exhaust gases 7.

According to the present invention, the heat energy of exhaust gas 7 is utilized by means of heat exchanger 2 for heating a reformer 10. Heat exchanger 2 in particular includes an inlet pipe 8 and an outlet pipe 9 for at least one fuel and/or one heating medium of reformer 10.

If appropriate, several usually physically separated heat exchange media may flow through heat exchanger 2 almost simultaneously. Alternatively, depending on the operating conditions of the system as a whole, a fuel or heating medium may be supplied to heat exchanger 2, one at a time.

For heating reformer 10 or its fuels, a catalytic burner 11 may be provided in addition.

For example, after engine start-up, internal combustion engine 1 is operated using reformed gas from an accumulator device, not illustrated in greater detail, thereby emitting almost no environmentally relevant exhaust gases 7. In particular, through operation using hydrogen, in particular without any significant amount of heat being drawn off by the heat exchanger, the operating temperature of a catalytic converter 12 is reached relatively rapidly. The amount of reformed gas until catalyst light-off is reached is relatively small and can be supplied from the pressure accumulator device, among others.

Preferably immediately after catalyst light-off is reached, engine 1 is operated, for example, using fuel 6 or a mixture of fuel and reformed gas 6, thereby very rapidly generating relatively high temperatures at exhaust pipe 3. Owing to the relatively high temperatures at exhaust pipe 3, one or all of the fuels and/or a separate reformer heating fluid may, if necessary, be heated without additional electric heating. The reformer is thus heated to operating temperature relatively rapidly, making it ready to generate reformed gas, or the hydrogen required for a fuel cell unit not illustrated in greater detail. If necessary, the reformed gas or the hydrogen is stored temporarily at operating pressure until it feeds engine 1 and/or the fuel cell unit at the next system start-up.

In general, the accumulator device for hydrogen or reformed gas necessary for self-sufficient fuel-cell vehicles may be left out or reduced in size by combining engine 1 with a fuel cell system. The lower operating pressure required also allows lowering of the fill pressure of the accumulator device and simplification of the reformer.

For example, for operating an auto-thermal reformer, hot steam may be provided via heat exchanger 2 according to the present invention. As an alternative, it is possible to supply the reformer during a start-up phase with relatively small amounts of water or none at all, resulting in a marked reduction in the heat energy required during start-up. In the latter case, for example, fuel 6 may be vaporized and the catalytically active reformer heated up. In this case, fuel 6 is transformed on the catalytically active surface, generally using atmospheric oxygen, thus releasing heat and in turn speeding up the heating phase.

Fundamentally, a heat exchanger 2 according to the present invention significantly improves overall efficiency by utilizing the exhaust gas energy. Through utilization of the exhaust gas energy, the electric heating of the catalytically active components and the required heating devices become unnecessary or may be reduced. In addition, the improved thermal conditions for operating the catalytic converter will significantly increase its life span.

what is claimed is:

1. A fuel cell system, comprising:
a combustion device having at least one exhaust pipe as an outlet for an exhaust gas;
a fuel cell unit;
a transforming unit for transforming a hydrocarbon-containing mixture of substances into a hydrogen-containing fluid; and
at least one heat exchanger unit positioned at the at least one exhaust pipe and for heating at least one of a heating fluid and a fuel of the transforming unit in accordance with a waste heat from the exhaust gas.

2. The device as recited in claim 1, wherein:
the at least one heat exchanger unit is situated in a proximity of an outlet opening of the combustion device.

3. The device as recited in claim 1, wherein:
the fuel contains, at least in part, the hydrocarbon-containing mixture of substances.

4. The device as recited in claim 1, wherein:
the fuel contains, at least in part, air.

5. The device as recited in claim 1, wherein:
the fuel contains, at least in part, water.

6. The device as recited in claim 1, further comprising:
at least one metering element for metering at least one of the fuel and the heating fluid.

7. The device as recited in claim 1, further comprising:
at least one catalytically active exhaust-gas purification device.

8. The device as recited in claim 7, wherein:
the at least one catalytically active exhaust-gas purification device is positioned in a direction of an exhaust flow, downstream from the at least one heat exchanger unit.

9. The device as recited in claim 1, further comprising:
at least one accumulator device for storing a hydrogen-enriched fluid.

10. A vehicle, comprising:
a fuel cell system, the fuel cell system including:
a combustion device having at least one exhaust pipe as an outlet for an exhaust gas,
a fuel cell unit,
a transforming unit for transforming a hydrocarbon-containing mixture of substances into a hydrogen-containing fluid, and
at least one heat exchanger unit positioned at the at least one exhaust pipe and for heating at least one of a heating fluid and a fuel of the transforming unit in accordance with a waste heat from the exhaust gas.

11. The vehicle as recited in claim 10, wherein:
the vehicle includes an automobile.
